(19) United States
(12) Patent Application Publication
(10) Pub. No.: US 2026/0123771 A1
(43) Pub. Date: May 7, 2026

(54) Open Fronted Cabinet with Air Curtain Control

(71) Applicant: The Alan Nuttall Partnership Limited, Hinckley, Leicestershire (GB)

(72) Inventor: Michael Steele, Hinckley, Leicestershire (GB)

(21) Appl. No.: 19/483,691

(22) PCT Filed: May 10, 2024
(86) PCT No.: PCT/EP2024/062907

§ 371 Date: Nov. 12, 2025

(30) Foreign Application Priority Data
May 12, 2023 (GB) 2307075.8

(51) Int. Cl. A47F 3/00

(52) U.S. Cl. CPC A47F 3/001

(57) ABSTRACT

An open fronted cabinet, having a first food display zone for the temporary display of a heated food item, the first food display zone comprising: a first fan associated with a first temperature control element and a first passageway; a second fan associated with a second temperature control element and a second passageway; wherein the first fan is configured to direct a first airflow, having a first temperature, through the first passageway into the first food display zone so as to create a first air curtain in the first food display zone and wherein the second fan is configured to direct a second airflow, having a second temperature, through the second passageway into the first food display zone so as to create a second air curtain in the first food display zone, wherein the first air curtain opposes the second air curtain to create a convective mixing zone in the first food display zone at a location where the first and second air curtain meet; and the open fronted cabinet further comprising a controller, the controller configured to: control the first and/or second air curtain by adjusting one or more of: a speed of the first fan; a speed of the second fan, a temperature of the first temperature control element; a temperature of the second temperature control element thereby modifying the temperature and/or location of the convective mixing zone in the first food display zone.

### FIELD OF THE INVENTION

The present invention relates to an open fronted cabinet and methods of operating such an open fronted cabinet for the display of heated food items.

### BACKGROUND OF THE INVENTION

Open fronted food display cabinets are regularly used in the food retail industry as a convenient means of giving consumers direct access to foods in regulated, typically non-room temperature conditions. The food within the open fronted cabinets must be held at specific temperatures dependent on the type of food item, with hot food items typically held at elevated temperatures greater than 65° C. The food items are held at the desired temperature and are not cooked by the open fronted food display cabinet. Therefore, such cabinets maintain the thermal energy held in the food item to keep the item at the same temperature.

Food display cabinets are cabinets which are placed in consumer facing environments and are designed to allow an unskilled end consumer to access the contents held in the cabinet. As such the food display cabinet will have various features such as lighting, safe touch temperatures etc., to allow the unskilled end consumer to access the food items held in the cabinet safely.

Such food cabinets typically comprise an air curtain provided by a fan which typically directs flow from the top of the cabinet to the bottom of the cabinet. The air curtains in such cabinets are impacted by environmental conditions such as volume of air, air speed, air temperature, and air mass which can prevent the food items being kept at the intended temperatures. Some cabinets can be limited in their functionality and some models are inefficient to run.

Refrigeration units can use multiple air curtains. Such units typically include a working air curtain to maintain the reduced temperatures in the unit and a defensive air curtain which works to protect the working air curtain from external factors. The working air curtain and the defensive air curtain do not work collaboratively. Rather, the defensive air curtain is a sacrificial air curtain to protect the working air curtain. In refrigeration units, cold dense air is used which falls to the bottom of the unit. Due to the higher density of cold air, the velocity of the air in the air curtains is reduced. Refrigeration units thus rely on gravity to displace the air flow downwards due to the mass of cold air. As such, the considerations for heated food cabinets and refrigeration units differ significantly.

Accordingly, the ability to improve and control open fronted food display cabinets is desirable.

An object of the present invention is to mitigate some of the deficiencies of the prior art mentioned above.

### SUMMARY OF THE INVENTION

In order to address some of the issues with the prior art there is provided an open fronted cabinet, having a first food display zone for the temporary display of a heated food item, the first food display zone comprising: a first fan associated with a first temperature control element and a first passageway, wherein the first fan is configured to direct a first airflow, through the first passageway, into the first food display zone so as to create a first air curtain in the first food display zone; the open fronted cabinet further comprising a controller, the controller configured to: receive an input from a first source, said input indicative of an event which would affect the formation of the first air curtain; and adjust the speed of the first fan and/or the temperature of the first temperature control element thereby controlling the formation of the first air curtain based on the received input.

By providing a controller in communication with a first source, the cabinet is able to maintain and alter the provided air curtain dependent on the environment of the cabinet. For instance, if the source identifies a draught originating in the environment where the unit is positioned and causing the units' interior conditions to deteriorate, the controller is able to adjust the fan and/or temperature control element accordingly. This dynamic alteration of the air curtain ensures that the food displayed in the cabinet is kept at the correct temperatures and that the integrity of the air curtain is maintained.

Optionally, further comprising one or more further sources. In this way, the cabinet is able to identify multiple conditions such as the environmental room temperature, disruptive draughts, presence of product on shelf etc. Further, the inclusion of multiple sources can allow conditions to be detected from different locations, such as interior to the cabinet and external to the cabinet.

Optionally, wherein a source is a sensor configured to measure an environment in which the open fronted cabinet is placed. Optionally, wherein the sensor is chosen from the group comprising: laser sensors, environmental sensors, temperature sensors, mass sensors, barometers, and humidity sensors. This enables different factors to be accounted for such as whether product is placed on a shelf using mass sensors, or whether the room temperature is causing the air curtain to operate at an incorrect temperature using temperature sensors.

Optionally, wherein the sensor is configured to measure a change in the air flow around the cabinet and/or first food display zone.

Optionally, wherein the sensor is configured to determine a presence of an object within the first food display zone.

Optionally, wherein a source is a timer which defines a time and/or temperature of the first air curtain.

Optionally, further comprising one or more further food display zones. Optionally, wherein each further food display zone has a fan and temperature control element, and the controller is configured to adjust the speed of the fan and/or the temperature of the temperature control element in each food display zone individually, thereby controlling the formation of the first air curtain in each food display zone separately. Providing multiple food display zones in a single cabinet enables more products to be displayed. As the individual food display zones each comprise a fan and temperature control element, they are individually operable such that the food display zones may be operated in different states (e.g., temperature) for different food products.

Optionally, wherein the food display zone further comprises a second fan having a second temperature control element and a second passageway; wherein the controller is configured to adjust the speed of the second fan and/or the temperature of the second temperature control element.

Another aspect of the invention provides an open fronted cabinet, having a first food display zone for the temporary display of a heated food item, the first food display zone comprising: a first fan associated with a first temperature control element and a first passageway; a second fan associated with a second temperature control element and a second passageway; wherein the first fan is configured to direct a first airflow, having a first temperature, through the first passageway into the first food display zone so as to create a first air curtain in the first food display zone and wherein the second fan is configured to direct a second airflow, having a second temperature, through the second passageway into the first food display zone so as to create a second air curtain in the first food display zone, wherein the first air curtain opposes the second air curtain to create a convective mixing zone in the first food display zone at a location where the first and second air curtain meet; the open fronted cabinet further comprising a controller, the controller configured to: control the first and/or second air curtain by adjusting one or more of: a speed of the first fan; a speed of the second fan, a temperature of the first temperature control element; a temperature of the second temperature control element thereby modifying the temperature and/or location of the convective mixing zone in the first food display zone.

By providing opposing air curtains, a convective mixing zone is created across the front of the cabinet. The turbulent airflow accelerates thermal mixing and heat convection, so as to provide a more uniform temperature throughout the interior space. The control of the fan(s) and temperature control element(s) means that the creation of the convective air curtain can be controlled and maintained. The air curtain can be controlled to provide a more uniform temperature profile and also allows for the curtain to be adapted according to usage and environmental conditions. Furthermore, the control of the air curtain can help to avoid ‘dead points’ within the interior space that may otherwise be underheated or overheated. Thus the opposing air curtains collaboratively mix together to provide the aforementioned benefits.

As the cabinet provides a first air curtain controllable by a first fan and temperature control element and a second air curtain controllable by a second fan and temperature control element, the first and second air curtain can be individually controlled to adjust the air curtain and convective mixing zone across the front of the cabinet. For example, the location of the convective mixing zone can be controlled to be in a location off centre or to continuously move throughout the air curtain. This is advantageous as the convective mixing zone can be most susceptible to disturbances which can cause the entire curtain to be unstable or even collapse. As such the ability to move the convective mixing zone away from disturbances ensures the integrity of the air curtain. Similarly, by controlling the temperature of the first and second air flow, the temperature of the air curtain and the convective mixing zone can be adjusted dependent on the food displayed in the food display cabinet.

Optionally, further comprising one or more sensors associated with the first food display zone, wherein the controller is configured to adjust in response to receiving data from the one or more sensors associated with the first food display zone one or more of: the speed of the first fan, the speed of the second fan, the temperature of the first temperature control element, the temperature of the second temperature control element.

The inclusion of sensors enables the controller to receive input data, and dependent on the input data, adjust the first/second fan and/or the first/second temperature control element to control the air curtain and convective mixing zone. For example, a sensor may identify a drop in temperature or a draught, in response to which the controller can instruct the temperature control element to operate at a higher temperature.

Optionally, wherein at least one of the one or more sensors are located within an interior of the open fronted cabinet. This allows the internal conditions of the cabinet to be monitored. For example, a mass sensor may determine whether product is placed in the food display zone.

Optionally, wherein at least one of the one or more sensors are located on an external surface of the open fronted cabinet. For example, a sensor could be used to determine if a customer has interrupted the air curtain or an employee has interrupted the air curtain to restock.

Optionally, wherein the controller is configured to be in communication with one or more external sensors configured to measure an environment in which the open fronted cabinet is placed. For example, a sensor could be placed on a door in the room in which the cabinet is located to monitor external temperatures and whether a draught is present due to an open door.

Optionally, wherein the one or more sensors are chosen from the group comprising: laser sensors, environmental sensors, temperature sensors, mass sensors, barometers, and humidity sensors.

Optionally, comprising four air temperature sensors and one or two air mass sensors.

Optionally, wherein the controller in accordance with one or more predefined settings is configured to adjust one or more of: the speed of the first fan, the speed of the second fan, the temperature of the first temperature control element, the temperature of the second temperature control element. The use of predefined settings enables the controller to automatically adjust the configurations as required. For example, the controller may comprise predefined settings that instructs the temperature of the temperature control elements to increase over a certain time period when different food product is placed in the cabinet over different day-parts of merchandising, i.e. breakfast or lunch periods.

Optionally, wherein the controller is configured to operate the first and second fan such that in use the location of the convective mixing zone moves from one side of the open fronted cabinet to another. This configuration enables the cabinet to better cope with the changing environmental conditions.

Optionally, further comprising an alarm configured to alert a user if the open fronted cabinet is outside of one or more predetermined working parameters. Such an alarm ensures the operator of the cabinet keeps the food items within the cabinet at sufficient temperature and conditions to comply with health and safety standards.

Optionally, further comprising a camera. Optionally, wherein the camera is an infrared camera. With this arrangement, the contents of the cabinet can more easily be viewed without interrupting the view of a consumer, and without having to be concerned with non-transparent components (e.g., fans, temperature control elements) of the cabinet blocking the view of the retailer.

Optionally, wherein the controller comprises different predefined settings for different heated food products. Such a configuration allows the food display zone to be controlled automatically dependent on which food item is contained within the food display zone.

Optionally, wherein the controller comprises an energy efficient configuration wherein at least one of: the speed of the first fan, the speed of the second fan, the temperature of the first temperature control element, the temperature of the second temperature control element—is decreased compared to normal working conditions. Such a configuration improves energy consumption.

Optionally, wherein the controller comprises a cool down configuration configured to lower the temperature of the convective mixing zone in the first food display zone.

Optionally, wherein the controller comprises a boost configuration wherein at least one of: the speed of the first fan; the speed of the second fan; the temperature of the first temperature control element; the temperature of the second temperature control element is increased compared to normal working conditions.

Optionally, wherein the controller comprises a scheduler configured to control the temperature and/or location of the convective mixing zone in the first food display zone in accordance with a time based schedule. This enables the convective mixing zone to be adjusted automatically dependent on the food item displayed in the cabinet.

Optionally, wherein the first and/or second passageway comprise an adjustable aperture, wherein the controller is further configured to adjust the volume and/or size of the adjustable aperture of the first and/or second passageway.

There is also provided a method of operating an open fronted cabinet having a first food display zone for the temporary storage of a heated food item, the first food display zone comprising: a controller; a first fan associated with a first temperature control element and a first passageway; a second fan associated with a second temperature control element and a second passageway; wherein the first fan is configured to direct a first airflow, through the first passageway, into the first food display zone so as to create a first air curtain in the first food display zone and wherein the second fan is configured to direct a second airflow, through the second passageway, into the first food display zone so as to create a first and second air curtain in the first food display zone, wherein the first air curtain opposes the second air curtain to create a convective mixing zone in the first food display zone at a location where the first and second air curtain meet; the method comprising the steps of: obtaining an indication of a desired temperature and location of the convective mixing zone; and controlling the first and/or second air curtain by adjusting one or more of: a speed of the first fan, a speed of the second fan, a temperature of the first temperature control element, a temperature of the second temperature control element thereby providing the desired temperature and/or location of the convective mixing zone in the first food display zone.

Optionally, wherein the open fronted cabinet comprises one or more sensors associated with the first food display zone, the method further comprising receiving data from the one or more sensors and controlling the first and/or second air curtain based on the received data.

Optionally, further comprising operating the first and second fan so as to move the location of the convective mixing zone from one side of the open fronted cabinet to another.

Optionally, further comprising sounding an alarm when the open fronted cabinet is outside of predetermined working parameters.

Optionally, wherein the first and second passageway comprise an adjustable aperture, the method further comprising adjusting a volume and/or size of the adjustable aperture of the first and/or second aperture.

Other aspects of the invention will be apparent from the appended claim set.

### BRIEF DESCRIPTION OF THE DRAWINGS

Embodiments of the invention will now be described with reference to the accompanying drawings, in which:

FIG. 1 is a perspective view of a front of a cabinet according to an aspect of the invention;

FIG. 2 is a schematic representation of the air flow within an interior space of a cabinet according to an aspect of the invention;

FIG. 3 is a flowchart of the process of adapting an air curtain according to an aspect of the invention;

FIG. 4 is a schematic representation of the air flow within an interior space of a cabinet according to an aspect of the invention;

FIG. 5 is a flowchart of the process of adapting an air curtain according to an aspect of the invention; and

FIG. 6 is a flowchart of the process of adapting an air curtain according to an aspect of the invention.

### DETAILED DESCRIPTION

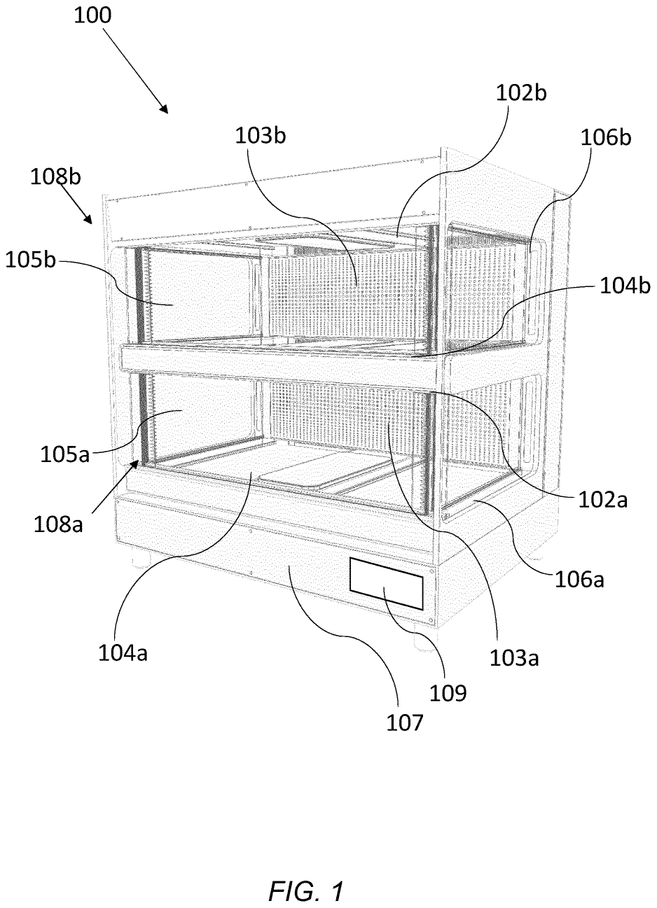

The present invention provides an open fronted cabinet and method of operating such a cabinet using a controller. Such a cabinet is shown in FIG. 1 in accordance with the claimed invention.

FIG. 1 shows a perspective view of an open fronted cabinet 100. The cabinet includes a first food display zone 108a defined by a first top 102a, rear 103a, base 104a, and opposed sides 105a, 106a. The first food display zone 108a is accessible through an opening to the front of the cabinet 100 defined between edges of the first top 102a, rear 103a, base 104a, and opposed sides 105a, 106a of the cabinet 100.

The first food display zone 108a of the cabinet 100 defines a space within which heated food items can be placed for subsequent selection and retrieval by a consumer. In particular, the base 104a may function as a shelf on which the heated food items are placed. The consumer can reach into the interior space through the opening in order to make and retrieve the selected food item.

The cabinet 100 may be modular, or otherwise constructed, so as to include multiple sections. For instance, a lower section that includes the first food display zone 108a and an upper section including a second food display zone 108b.

FIG. 1 shows the cabinet 100 including a second food display zone 108b defined by a second top 102b, rear 103b, base 104b, and opposed sides 105b, 106b. The second food display zone is accessible through a second opening to the front of the cabinet 100 defined between edges of the second top 102b, rear 103b, base 104b, and opposed sides 105b, 106b of the cabinet 100.

The cabinet 100 is arranged such that each food display zone is adjacent to another food display zone. In the example shown in FIG. 100, the first top 102a, rear 103a, base 104a, and opposed sides 105a, 106a define a first food display zone 108a that is below the second top 102b, rear 103b, base 104b, and opposed sides 105b, 106b that define a second food display zone 108b.

In this case, the top 102a of the first food display zone 108a may form at least part of the base 104b of the second food display zone 108b. Alternatively, the top 102a of the first food display zone 108a may be separated from the base 104b of the second food display zone 108b, for example separated by an air gap to improve insulation between the interior spaces.

The food display zones 108a, 108b may rest upon a chassis 107. The chassis 107 may house various components of the cabinet 100, such as a controller 109, that controls various features of the cabinet 100. For example, a fan, temperature control element, display and camera may each be controlled by a controller. The camera and display can be used by a user to determine how much stock is contained within the cabinet 100 and whether a restock is required, for example. Such a camera can be an infrared camera. The cabinet 100 also comprises one or more sources in communication with the controller 109.

The camera can be used to monitor, using known image analysis techniques, when a disruption to the curtain is likely to occur. In an example, using the camera an object, such as a hand, entering the air curtain can be identified and the position of the object determined using known techniques. If it is determined that the position of the object is likely to affect the air curtain, as described in detail below, the location of a convective mixing zone can be moved away from the object so as to minimise disruption and ensure the integrity of the air curtain.

The cabinet 100 may further comprise an alarm. The alarm is configured to emit a warning in situations such as when the cabinet 100 is overstocked and/or when the cabinet 100 is operating in unsafe working conditions which do not meet health and safety standards (for example, the food within the cabinet 100 is being held at unsafe temperatures for consumption).

In the following, the first food display zone 108a of the cabinet 100 will be described, although it will be appreciated that other sections of the cabinet 100, such as the second food display zone 108b, may be the same or substantially similar.

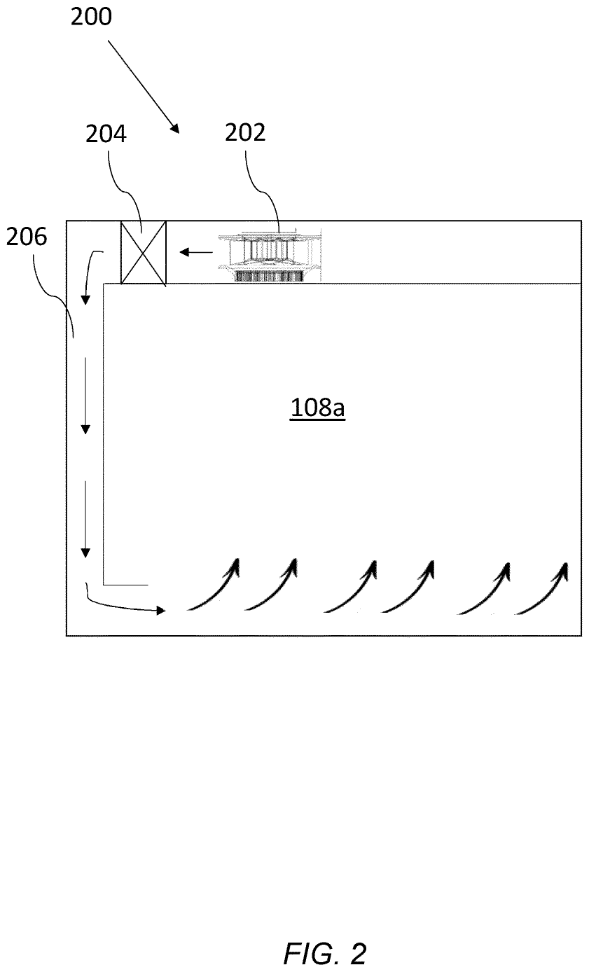

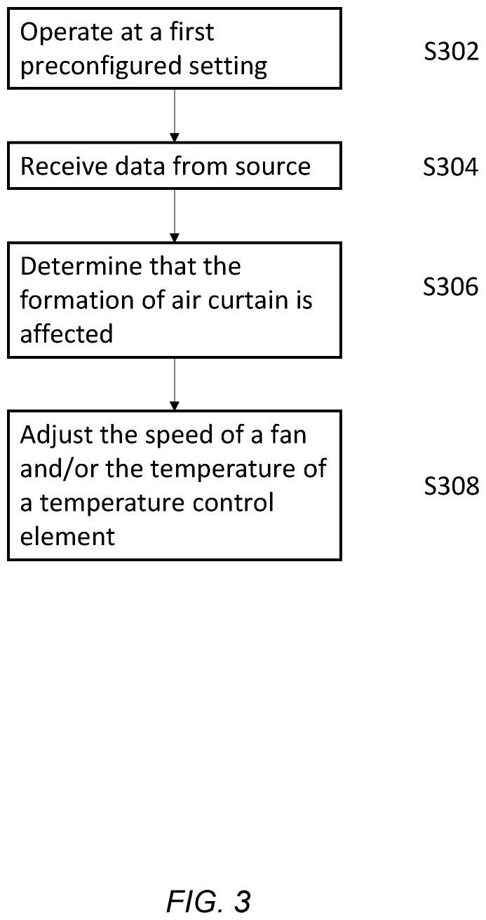

FIG. 2 is a schematic representation 200 of the air flow within an interior space of a cabinet 100 in an embodiment where cabinet 100 comprises a first fan. As described in detail below, with reference to FIG. 3, an aspect of the cabinet 100 is that it is configured to dynamically sense changes in the environment in which the cabinet 100 is placed and adjust the operation of the fan to control the formation of the air curtain. The air curtain is a heated air curtain so as to ensure the maintenance of the temperatures of the heated food items in the cabinet 100. For example, if it is determined that the environmental conditions are such that the air curtain in the cabinet 100 would be affected, or disturbed, the cabinet is configured to adjust the fan and/or temperature control element to maintain the integrity of the air curtain.

A camera can be provided in the cabinet 100 of FIG. 2 to monitor disruptions to the air curtain which could impact the integrity of the air curtain. For example, the camera may detect a hand entering the air curtain from an employee restocking the cabinet and alter the fan and/or temperature control element appropriately to maintain the integrity of the air curtain.

The air curtain is a hot air curtain. As the temperature of the air is elevated to the required temperature, the speed of the air flow is increased and the density of the air is reduced compared with the low air flow and dense air in an open fronted refrigeration unit, for example. The use of hot air allows the direction and velocity of the air flow to be controlled. This is not the case for open fronted refrigeration units which rely on gravity to direct the air downwards to ensure little or no turbulence. Open fronted refrigerators are dependent on ensuring extremely low air velocities and thus the direction and velocity of cold air in refrigeration units cannot be controlled or varied as this increases turbulence and causes the air curtain to entrain air from the environment, which is significantly hotter than the refrigerated interior. In the cabinet 100, the air curtain is provided over an opening of a compartment in the cabinet 100. As the air curtain uses hot air, the direction of air flow in the air curtain can be controlled. For example, the air curtain could be directed to form a vertical air curtain, or the air flow could come in from one or more corners of the cabinet, or the air curtain could be directed from every edge of the cabinet. Such air curtains cannot be used at cold temperatures (e.g., in a refrigeration unit) as cold air curtains rely on gravity as this is the least turbulent method of creating an air curtain. As this is a requirement, all open fronted refrigeration units have a downward direction for the air curtain. In open fronted refrigeration units, the velocity of the air is kept purposely low to reduce turbulence and entrainment. In contrast, the present cabinet 100 is able to control the velocities of the air flow and thus control the direction of the air curtain.

The cabinet 100 includes one fan 202 configured to flow hot air into one or more of the interior spaces of the cabinet 100. The fan 202 may be controlled by a DC motor, or other means, so that the speed and/or volume of air exiting the fan 202 can be controlled. The cabinet 100 further comprises a temperature control element 204 configured to control the temperature of the air flow provided by the fan 202. This allows the air flow to be controlled, for example so that the system can respond to internal temperature or temperature variations within the interior space or environmental factors such as external temperature or wind. The temperature control element is used to maintain the air curtain at an appropriate heated temperature. The fan 202 and the temperature control element 204 may be located in any suitable position on the cabinet 100, although the fan 202 and temperature control element 204 are preferably located adjacent a rear side 103a of the cabinet 100. This prevents the fan 202 and temperature control element 204 from blocking the view of the consumer through the front of the cabinet 100, or one of the sides 105a, 106a, whilst also providing a convenient location for creating circular flow.

The fan 202 may be any suitable fan such as an axial fan, centrifugal fan, or cross flow fan. The fan 202 and temperature control element 204 are located in a passageway 206 extending from the fan 202 to the front of the cabinet 100. The passageway 206 preferably extends along one of the opposed sides 105a, 106a of the cabinet 100. Alternatively, the passageway 206 can extend along the top 102a and/or base 104a of the cabinet 100.

The passageway 206 extends to the front of the cabinet 100 so as to direct air flow, via the fan 202, across the front of the cabinet 100, and in particular across the front of the first food display zone 108a. The end of the passageway 206 may include an adjustable aperture (not shown) to direct the air flow. The adjustable aperture can be controlled by the controller 109 to adjust the volume of air being expelled at a given time. This creates a heated air curtain that helps to prevent heat transfer between the interior space and the air outside the cabinet 100, whilst allowing convenient access to the interior space without the need for a door on the front of the cabinet 100. The heated air curtain creates a seal in the cabinet 100 to maintain the temperature of the heated food items. This is particularly advantageous when a user places their hand, for example, in the cabinet 100 and the air curtain is able to reseal around the user's hand to maintain the integrity of the air curtain. As an example, the air curtain may be a vertical air curtain. Alternatively, the air curtain may be directed from the corners of the cabinet 100 or from some other arrangement.

The controller 109 associated with the first food display zone 108a (or, alternatively associated with the cabinet 100 as a whole) is used to control the fan 202 and the temperature control element 204. The controller 109 is in communication with a computer which is configured to access information from a database. The database can store relevant information related to different preconfigured settings for different heated food items. For example, the controller may store a fan setting for the speed of the fan 202 and a temperature setting for the temperature of the temperature control element 204 for when the first food display zone 108a is holding a certain heated food product. For example, the speed and temperature setting may be higher when the first food display zone 108a is holding hot soup compared to when it is holding products such as hot breakfast sandwiches.

The controller 109 may be further configured to change between preconfigured settings at certain times of the day. For example, the controller 109 may be configured to hold the first food display zone 108a at a first group of settings at 9am and then automatically swap to a second group of settings at 12pm, for instance.

The controller 109 is in communication with one or more sources. The source can be a sensor configured to measure the environment in which the cabinet 100 is placed. For example, the sensor can be a laser sensor, infrared sensor, environmental sensor, temperature sensor, mass sensor, barometer and/or humidity sensor. Such sources can be placed in the interior of the first food display zone 108a, on an external surface of the cabinet 100, or a surface separate to the cabinet 100 within the surrounding environment of the cabinet 100. For example, the source could be positioned on a door at the entrance/exit of a retail environment in which the cabinet 100 is placed. The sensors are used to detect/determine a likely disturbance to the air curtain. This can be used to adaptively and pre-emptively change the air curtain to reduce disruption.

In further embodiments the cabinet 100 may comprise one or more further fans and temperature control elements.

In response to receiving data from one or more sources, the controller 109 can adjust the fan 202 and/or temperature control element 204 settings, as described below in relation to FIG. 3.

FIG. 3 is a flowchart of the process of adapting a heated air curtain in a cabinet 100 according to an aspect of the invention.

The cabinet 100 is configured to sense a change in the environment in which the cabinet is placed. As described below, the change in the environment may result in the air curtain(s) being affected, and the cabinet adjusts its operation, by altering the operating parameters of the fan(s) and/or temperature control element(s) to maintain the integrity of the air curtain. Advantageously, by dynamically adjusting the formation of the air curtain the air curtain can be maintained in changing environments. For example, a cabinet 100 may be placed in a retail location near a door which could intermittently expose the cabinet 100 to a breeze (for example when the door is open). Such a breeze could affect the air curtain and by adjusting the operating parameters of the fan(s) and/or temperature control element(s) the air curtain can be maintained.

Initially at step S302 the controller 109 can be operating under a first preconfigured setting which assumes a particular environment and a particular heated food product. Different environments and food products can have different preconfigured settings stored by the controller 109. For example, an environment in which the cabinet 100 is placed by a door of the retailer and holding soup products will have a different preconfigured setting to an environment in which the cabinet 100 is placed away from a door of the retailer and/or holding hot sandwiches. The first preconfigured setting can be overridden dependent on the data received by the controller 109 from the one or more sources.

At step S304, the controller 109 of the cabinet 100 receives data from a first source. The controller 109 may receive additional data from further sources associated with the cabinet 100. As discussed above in relation to FIG. 2, the sources can be sensors configured to detect the environment within and outside of the food display zones. The sensors can measure a change in airflow around the cabinet 100 (and food display zones) and/or detect the presence of an object within the food display zones. For example, the sensor may be a camera which detects when a customer has their hand within the cabinet 100 when choosing a heated food product or may detect when a user is restocking the cabinet 100. The source may also be a timer which defines the time and/or temperature of the air curtain.

Preferably, the cabinet 100 comprises four air temperature sensors and one or two air mass sensors to provide optimum coverage of the conditions of the food display zone.

Using the received data, the controller 109 determines, at step S306, whether the formation of the heated air curtain is affected. For example, a temperature sensor may indicate that the temperature of the air curtain is above/below the desired temperature or an environmental sensor may detect a draught which is interrupting the air flow.

If the air curtain is affected, the process proceeds to step S308 where the controller 109 adjusts the speed of the fan 202 and/or the temperature of the temperature control element 204 in order to maintain the intended air curtain.

The air curtain across the first food display zone 108a of the cabinet 100 may be impacted from various environmental factors. For example, there may be a draught from an open door which causes the temperature of the air curtain and/or speed of the air curtain to change. Upon detection of such a change, the controller 109 is able to instruct the fan 202 to operate at a different speed and/or instruct the temperature control element 204 to operate at a different temperature. This restores the air curtain to the intended form and ensures food products within the food display zones are kept at the correct temperatures. For example, as the cabinet 100 is designed to hold heated food products rather than refrigerated products, the temperature of the temperature control element 204 will be increased if there is an external disruptive airflow which lowers the temperature of the heated air curtain. For example, there may be an external air flow such as wind having a certain velocity and direction which disrupts the air curtain, for example when a door to a location containing the cabinet 100 is opened.

In an embodiment the controller 109 accesses a database which comprises a number of predetermined responses which can be enacted at step S308 in response to the determination that the air curtain is affected at step S306. The database comprises a number of predefined scenarios based on the data received from the one or more sources at step S304. These scenarios include, but are not limited to, various temperature, humidity, air pressure ranges that may be detected at step S304. At step S308 the controller is configured to identify the scenario in the database which most closely matches the data received from the data sources at step S304. Each scenario is further associated with a predetermined response which the controller 109 then enacts at step S308.

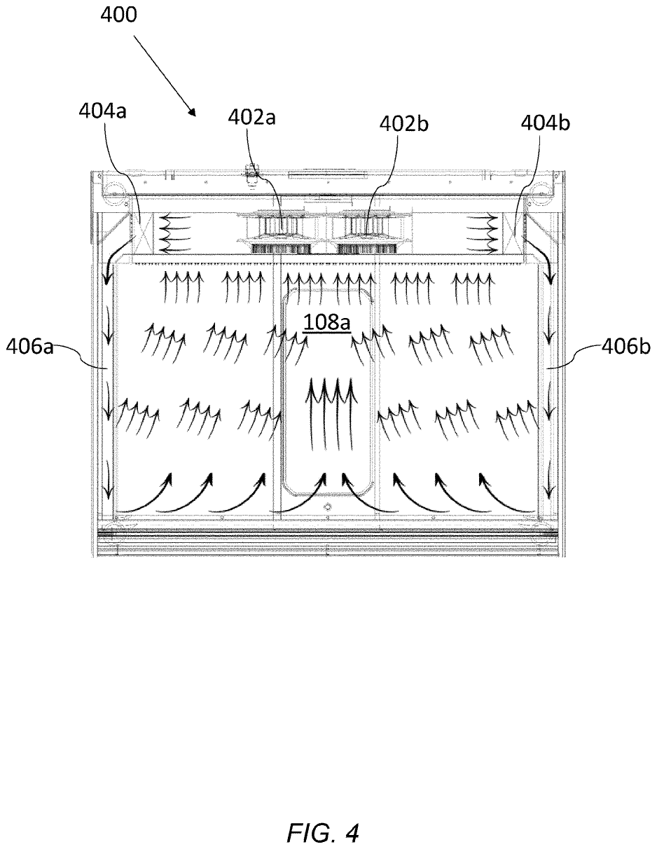

FIG. 4 is a schematic representation 400 of the air flow within a food display zone of the cabinet comprising two fans.

In contrast to the scenario shown with respect to FIG. 2, the use of multiple fans allows for two, or more, opposing air curtains to form within the first food display zone 108a. The cabinet 100 is configured to hold heated food products such that the opposing air curtains are heated air curtains comprising hot air rather than cold air. Hot air differs from cold air in that the density of hot air is reduced and the speed of the air flow is faster. Open fronted refrigeration units are reliant on cold air which falls to the bottom of the cabinet due to the increased density and gravity and thus cannot form collaborative air curtains. Open fronted refrigeration units thus only work in a single configuration, namely with an air curtain directed downwards. The air curtains of cabinet 100 have the possibility of multiple directions as the velocity and direction of the hot air can be controlled. This is not the case for open fronted refrigeration units which rely on gravity to direct the air downwards and thus the direction and velocity of cold air in open fronted refrigeration units cannot be controlled or varied. In the cabinet 100, the air curtains are provided over an opening of a compartment in the cabinet 100. As the air curtains use hot air, the direction of air flow in the air curtains can be controlled. For example, the air curtains could be directed to form a vertical air curtains, or the air flow could come in from one or more corners of the cabinet, or the air curtain could be directed from every edge of the cabinet. Such air curtains cannot be used at cold temperatures (e.g., in an open fronted refrigeration unit) as cold air is reliant on displacement due to gravity and high velocity cold air would cause entrainment. In open fronted refrigeration units, the velocity of the air is kept purposely low to reduce turbulence and entrainment. In contrast, the present cabinet 100 is able to control the velocities of the air flow and thus control the direction of the air curtains.

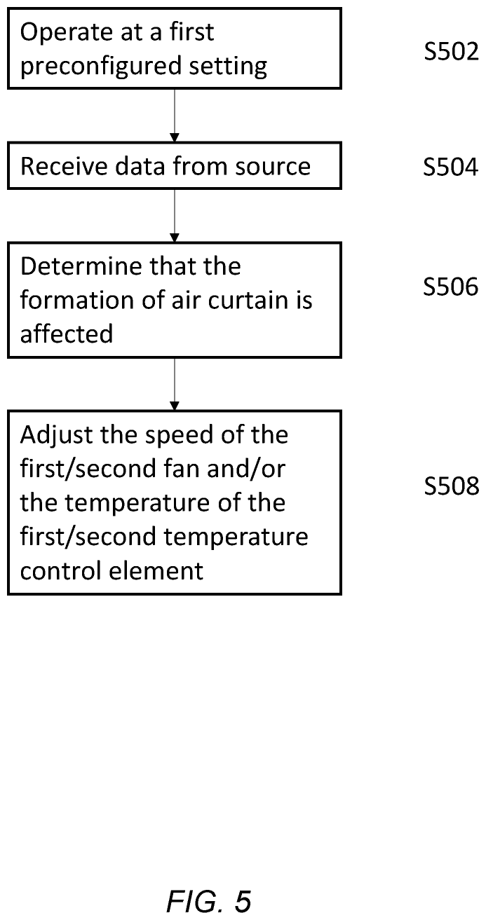

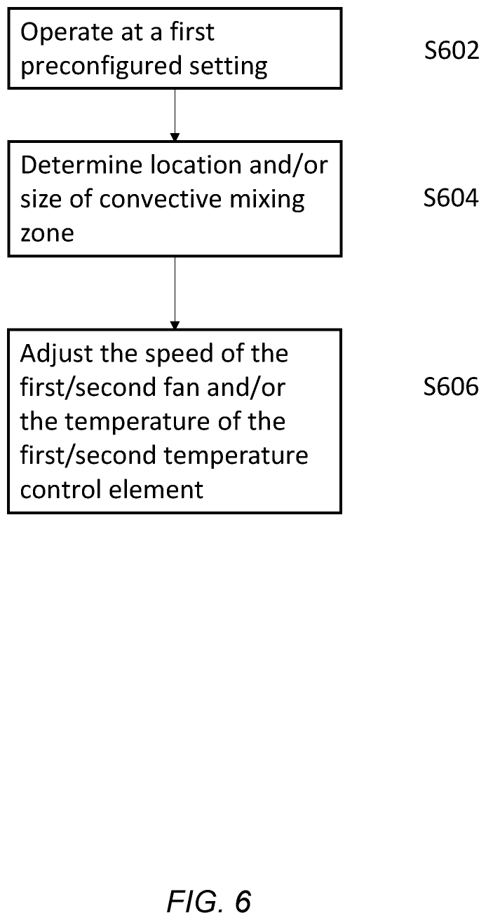

As described in detail below, with reference to FIGS. 5 and 6, the cabinet 100 is adapted to control each of the opposing air curtains individually providing greater control over the heating of the first food display zone 108a.

The air flow from the first fan meets the air flow from the second fan to create an area of turbulent air flow called the convective mixing zone. The curtains work together collaboratively to create a collaborative seal in the cabinet 100 which maintains the temperature of the heated food products. The seal maintains the integrity of the food curtain and thus the temperature of the heated food items. For example, if a user places their hand in the air curtains, the air curtains reform around the hand to reseal the air curtains and maintain the internal temperature of the cabinet 100.

In the embodiment shown in FIG. 4, the first food display zone 108a may comprise a first fan 402a associated with a first temperature control element 404a and a second fan 402b associated with a second temperature control element 404b. Therefore, each fan is independently configurable of the other fan. The first fan 402a and the second fan 402b may be placed so as to direct air flow to opposite sides of the first food display zone 108a.

The temperature control element 404a, 404b may be a heater element configured to increase a temperature of the airflow in the passageway 406a, 406b. For example, the heater element may include a coil heater, band heater, circulation heater or any other suitable heater element known in the art. Such a heater element may also be employed in the single fan embodiment.

The first fan 402a, in combination with the first temperature control element 404a, is configured to direct air flow at a first speed and temperature along the first passageway 406a and across the front of the first food display zone 108a. The second fan 402b, in combination with the second temperature control element 404b, is configured to direct air flow at a second speed and temperature along the second passageway 406b and across the front of the first food display zone 108a.

The passageways 406a, 406b extend to the front of the cabinet 100 so as to direct air flow across the front of the first food display zone 108a. This creates opposing air curtains that help to prevent heat transfer between the interior space and the air outside the cabinet 100, whilst allowing convenient access to the interior space without the need for a door on the front of the cabinet 100. In this configuration such an air curtain would be a substantially vertical air curtain in the first food display zone 108a. The collaborative mixing of the opposing air curtains at a convective mixing zone creates a seal which maintains the temperature of the heated food items. Unlike open fronted refrigeration units, there is no sacrificial air curtain but rather both air curtains merge and work collaboratively to maintain the internal temperature of the compartment by preserving the air curtain seal.

As the air curtains are opposing, they meet at a location across the front of the cabinet 100 so as to create a turbulent flow inside the interior space of the cabinet 100. The turbulent flow of the air curtains unifies the air curtains to collaboratively stitch together at any location. This location is called the convective mixing zone. The convective mixing zone can be at any location in the cabinet 100 and can be determined by a user or automatically by a processor. For example, the convective mixing zone may be at the middle of the cabinet 100, the left side of the cabinet, the right side of the cabinet, a corner of the cabinet, or any other appropriate location. The convective mixing zone does not have to be fixed to a particular location and this collaborative mixing zone can be moved to a determined fixed location or can be continuously moved between locations. For example, the convective mixing zone may continuously move from the left side of the cabinet to the ride side of the cabinet and vice versa. Thus, the location of the convective mixing zone can change over time. The turbulent airflow increases thermal mixing and heat convection, and this provides a more uniform temperature throughout the interior space. This helps to avoid “dead points” within the interior space that may otherwise be underheated or overheated.

Such a convective mixing zone cannot be achieved in a refrigeration unit using the techniques of the present application as the turbulent airflow causes turbulence and entrainment of the air curtain. Further, the open fronted refrigeration unit is dependent on gravity which causes the cold air to fall towards the bottom of the cabinet due to the higher mass of cold air.

In the example shown in FIG. 4, the air curtains meet in a middle of the opening of the cabinet 100. However, it will be appreciated that the air curtains may meet at any position across the front of the cabinet 100 so as to create the desired conditions in the interior space. For example, in the form of the substantially vertical air curtain. The position at which the opposing air curtains meet may be tailored to create differential turbulence or temperature in parts of the interior space. Advantageously, having two opposing air flows allows the size and location of the convective mixing zone to be altered.

The controller 109 is configured to adjust the speed of the first fan 402a, the speed of the second fan 402b, the temperature of the first temperature control element 404a and the temperature of the second temperature control element 404b in order to maintain or alter the air curtain across the first food display zone 108a.

Similar to the embodiment comprising one fan, the controller 109 is configured using stored configurations (i.e., predefined settings) and/or in response to receiving data from one or more sources. The stored configurations comprise particular temperature and speed settings for the air curtain using the fans 402a, 402b and temperature control elements 404a, 404b. A number of configurations are described below which can be stored by the controller 109 and implemented on user request or in response to source data. The configuration may be chosen dependent on the particular heated food item placed in the food display zone and based on the environment in which the cabinet 100 is located.

A first air curtain configuration comprises adjusting the speed settings of the first fan 402a and the second fan 402b such that the location of the convective mixing zone moves from one side of the first food display zone 108a to the other. For example, the convective mixing zone may initially be located at the left-hand side of the first food display zone 108a and controlled by the controller 109 such that the convective mixing zone gradually moves from the left hand side to the right hand side of the first food display zone 108a. This configuration can be repeated such that the convective mixing zone is continually moving from left to right and vice versa. Thus, the location of the collaborative mixing zone of the two air curtains can be adjusted as required. Such a configuration is better able to cope with the environmental conditions such as when a door of the retailer is open.

The convective mixing zone is the weakest portion of the air curtains and is more susceptible to disruption. By enabling the convective mixing zone to move, or ‘sweep’, between multiple locations, the air curtains resistance to environmental factors is improved. For example, the convective mixing zone can be moved away (and kept away) from a disrupted portion of the air curtain caused by environmental factors. The stability of the entire air curtain is improved when the disruption does not occur at the convective mixing zone. Once the disruption has ceased, the convective mixing zone may move back to the original (or a new) location or may resume the continuous motion from one side of the display to the other and so on.

As described in relation to FIG. 2, for example, the disruption may be detected by a camera using image analysis techniques and the disruption may be due to a user placing their hand in the cabinet 100 which disrupts the air flow. The disruption may also or alternatively be detected by temperature sensors which are able to detect a reduction in temperature due to a cold external airflow. Any appropriate sensor can be used to detect a disruption to the airflow.

A second air curtain configuration comprises an energy efficient configuration. In this configuration, the temperature of the first/second temperature control elements 404a, 404b and the speed of the first/second fan 402a, 402b may be reduced compared to normal working conditions. Additionally, or alternatively, the time taken for the first food display zone 108a to reach intended working conditions may be increased so that the first food display zone 108a reaches the intended temperature/air flow speed in an energy efficient manner. Normal working conditions refers to a standard working condition which is typically used by that retailer for the particular heated food item displayed in the cabinet. This configuration is also applicable to the one fan embodiment.

A third air curtain configuration comprises a cool down configuration configured to lower the temperature of the convective mixing zone in the first food display zone 108a. Such a configuration may be employed when the cabinet 100 transitions from holding heated food items at a higher temperature to holding heated food items at a lower temperature. This configuration is also applicable to the one fan embodiment.

A fourth air curtain configuration comprises a boost configuration wherein the speed of the first/second fan 402a, 402b and/or the temperature of the first/second temperature control element 404a, 404b is increased compared to normal working conditions. Additionally, or alternatively, the time taken to reach the desired working conditions is decreased such that the cabinet reaches operating conditions quicker than usual. Such a configuration is useful during selling periods where the heated food item being held in the cabinet 100 changes and the retailer requires the newly held heated food items to be held at a higher temperature than the previous food items. This configuration is also applicable to the one fan embodiment.

Another air curtain configuration comprises a scheduler. The scheduler controls the temperature and/or location of the convective mixing zone based on, for example, the type of heated food product and/or time of day. For example, the scheduler configuration may have a first group of settings for 9am-12pm when holding hot breakfast sandwiches and then a second group of settings for 12pm-5pm when holding hot soup.

It is understood that the above configurations can be combined and implemented in the same food display zone. For example, the energy efficient configuration can operate with the adjustment of the convective mixing zone configuration.

FIG. 5 is a flowchart of the process of adapting a heated air curtain according to an aspect of the invention wherein the cabinet 100 has two fans 402a, 402b. Similar steps to the steps of FIG. 3 are carried out.

Initially at step S502, the controller 109 can be operating under a first preconfigured setting which assumes a particular environment and a particular heated food product. The first preconfigured setting can be overridden dependent on the data received by the controller 109 from the one or more sources. As detailed above with respect to FIG. 4, the preconfigured settings result in the creation of a substantially vertical air curtain in the food display zone.

At step S504, the controller 109 of the cabinet 100 receives data from a first source. The controller 109 may receive additional data from further sources associated with the cabinet 100. For example, the controller 109 may receive data from a temperature sensor located in the environment of the cabinet 100 which indicates that the ambient temperature in the environment is low.

The sensor may additionally or alternatively be a camera. The camera is able to detect a likely disruption to the air curtain using known image analysis techniques. For example, when a customer places their hand in the cabinet 100 to obtain a heated food item or when an employee is restocking the heated food items.

Preferably, the cabinet 100 comprises four air temperature sensors and 2 air mass sensors to provide optimum coverage of the conditions of the food display zone.

Using the received data, the controller 109 determines, at step S506, whether the formation of the air curtain is affected. For example, the controller 109 may determine that the convective mixing zone is not located in the desired location, for example, the centre of the first food display zone 108a, due to a draught entering from an open door of the retail environment. As another example, the controller may determine that the temperature of the convective mixing zone is too low (as a result of the ambient temperature in the environment of the cabinet).

If the air curtain is affected, the process proceeds to step S508 where the controller 109 adjusts the speed of the first/second fan 402a, 402b and/or the temperature of the first/second temperature control element 404a, 404b in order to maintain or restore the intended air curtain. For example, the temperature of the first and second temperature control elements 404a, 404b may be increased to counter the cold environment of the retailer.

As an example, the first food display zone 108a of the cabinet 100 may be operating at a first preconfigured setting in which the air curtain is held at a temperature of between 15% and 20% higher than the cabinet 100 interior set temperature and the convective mixing zone is located in the centre of the first food display zone 108a. The controller 109 may then receive data from a temperature sensor and environmental sensor located in the environment of the retailer which indicates that the temperature of the environment is less than 16 degrees Celsius and that there is a significant draught coming from the left-hand side of the cabinet 100 having an airspeed in advance of 1.0 metres/second. The controller 109 then determines that such conditions impact the air curtain by, for example, causing the convective mixing zone to move towards the right of the cabinet 100 and therefore be off centre and causing the temperature of the air curtain and convective mixing zone to lower. The convective mixing zone where the air flow from the first and second fan meet is the weakest point of the air curtain. The controller 109 then instructs the second fan 402b to operate at a higher speed and instructs the temperature control elements 404a, 404b to operate at a higher temperature thus restoring the convective mixing zone to the desired location/temperature of the preconfigured setting. Moving the convective mixing zone in response to external factors ensures the integrity of the air curtain.

FIG. 6 is a flowchart of the process of adapting an air curtain according to an aspect of the invention wherein the cabinet 100 has two fans 402a, 402b.

At step S602, the controller 109 can be operating under a first preconfigured setting which assumes a particular environment and a particular heated food product. The first preconfigured setting can be overridden dependent on the determinations of the controller 109.

At step S604, the controller 109 is configured to determine the location and/or the size of the convective mixing zone creating the substantially vertical air curtain in the first food display zone 108a. For example, the controller 109, in communication with one or more sources, may determine that the convective mixing zone is located to the right of the centre of the first food display zone 108a but should be located to the left of the centre of the first food display zone 108a. Similarly, the controller 109, in communication with one or more sources, may determine that the convective mixing zone is smaller in size than intended.

In response to this determination that the location and/or size of the convective mixing zone are not as intended by the preconfigured setting, the controller proceeds to step S606. At step S606 the controller 109 adjusts one or more of: the speed of the first fan 402a, the speed of the second fan 402b, the temperature of the first temperature control element 404a, and/or the temperature of the second temperature control element 404b to restore the convective mixing zone. For example, to restore the convective mixing zone to the left of the centre of the first food display zone 108a, the controller 109 can instruct the second fan 402b to operate at a higher speed. To restore the size of the convective mixing zone, the controller 109 may instruct the fans 402a, 402b to operate at new speeds.

The controller 109 is also configured to determine whether the components such as the first/second fan 402a, 402b and the first/second temperature control elements 404a, 404b are fully functioning. For example, the controller 109 may determine that the first fan 402a is under performing or faulty and therefore not outputting the required volume of air for the required setting. In response to this determination, the controller 109 instructs the first fan 402a to work at a higher speed to output the required volume of air. For example, the location of the convective mixing zone is required at the centre of the first food display zone 108a and thus the first and second fan 402a, 402b are operating at the same speed and the first and second temperature control elements 404a, 404b are operating at the same temperature. However, the first fan 402a is determined as faulty such that the location of the convective mixing zone is left of centre. The controller 109 thus instructs the first fan 402a to operate at a first higher speed than the second fan 402b to move the convective mixing zone back to the centre of the first food display zone 108a and subsequently operates the first fan 402a at a second higher speed such that both fans are providing the same volume of air and the convective mixing zone is maintained at the centre of the first food display zone 108a.

1. An open fronted cabinet, having a first food display zone for the temporary display of a heated food item,
the first food display zone comprising:
a first fan associated with a first temperature control element and a first passageway;
a second fan associated with a second temperature control element and a second passageway;
wherein the first fan is configured to direct a first airflow, having a first temperature, through the first passageway into the first food display zone so as to create a first air curtain in the first food display zone and wherein the second fan is configured to direct a second airflow, having a second temperature, through the second passageway into the first food display zone so as to create a second air curtain in the first food display zone, wherein the first air curtain opposes the second air curtain to create a convective mixing zone in the first food display zone at a location where the first and second air curtain meet, wherein the convective mixing zone is an area of turbulent airflow in which the first and second air curtains are dynamically opposed and are united to collaboratively stitch together; and
the open fronted cabinet further comprising a controller, the controller configured to:
control the creation of the convective mixing zone by adjusting one or more of: a speed of the first fan; a speed of the second fan, a temperature of the first temperature control element; a temperature of the second temperature control element thereby modifying the temperature and/or location of the convective mixing zone in the first food display zone.

2. The open fronted cabinet of claim 1 further comprising one or more sensors associated with the first food display zone, wherein the controller is configured to adjust in response to receiving data from the one or more sensors associated with the first food display zone one or more of: the speed of the first fan, the speed of the second fan, the temperature of the first temperature control element, the temperature of the second temperature control element.

3. The open fronted cabinet of claim 2, wherein at least one of the one or more sensors are located within an interior of the open fronted cabinet.

4. (canceled)

5. The open fronted cabinet of claim 1, wherein the controller is configured to be in communication with one or more external sensors configured to measure an environment in which the open fronted cabinet is placed.

6. The open fronted cabinet of claim 2, wherein the one or more sensors are chosen from the group comprising: laser sensors, environmental sensors, temperature sensors, mass sensors, barometers, and humidity sensors.

7. (canceled)

8. The open fronted cabinet of claim 1, wherein the controller in accordance with one or more predefined settings is configured to adjust one or more of: the speed of the first fan, the speed of the second fan, the temperature of the first temperature control element, the temperature of the second temperature control element.

9. The open fronted cabinet of claim 1, wherein the controller is configured to operate the first and second fan such that in use the location of the convective mixing zone moves from one side of the open fronted cabinet to another.

10. The open fronted cabinet of claim 1, further comprising an alarm configured to alert a user if the open fronted cabinet is outside of one or more predetermined working parameters.

11. (canceled)

12. (canceled)

13. (canceled)

14. The open fronted cabinet of claim 1, wherein the controller comprises an energy efficient configuration wherein at least one of: the speed of the first fan, the speed of the second fan, the temperature of the first temperature control element, the temperature of the second temperature control element—is decreased compared to normal working conditions.

15. (canceled)

16. (canceled)

17. The open fronted cabinet of claim 1, wherein the controller comprises a scheduler configured to control the temperature and/or location of the convective mixing zone in the first food display zone in accordance with a time based schedule.

18. The open fronted cabinet of claim 1 wherein the first and/or second passageway comprise an adjustable aperture, wherein the controller is further configured to adjust the volume and/or size of the adjustable aperture of the first and/or second passageway.

19. A method of operating an open fronted cabinet having a first food display zone for the temporary storage of a heated food item, the first food display zone comprising:
a controller;
a first fan associated with a first temperature control element and a first passageway;
a second fan associated with a second temperature control element and a second passageway;
wherein the first fan is configured to direct a first airflow, through the first passageway, into the first food display zone so as to create a first air curtain in the first food display zone and wherein the second fan is configured to direct a second airflow, through the second passageway, into the first food display zone so as to create a first and second air curtain in the first food display zone, wherein the first air curtain opposes the second air curtain to create a convective mixing zone in the first food display zone at a location where the first and second air curtain meet, wherein the convective mixing zone is an area of turbulent airflow in which the first and second air curtains are dynamically opposed and are united to collaboratively stitch together;
the method comprising the steps of:
obtaining an indication of a desired temperature and location of the convective mixing zone; and
controlling the creation of the convective mixing zone by adjusting one or more of: a speed of the first fan, a speed of the second fan, a temperature of the first temperature control element, a temperature of the second temperature control element thereby providing a desired temperature and/or location of the convective mixing zone in the first food display zone.

20. The method of claim 19, wherein the open fronted cabinet comprises one or more sensors associated with the first food display zone, the method further comprising receiving data from the one or more sensors and controlling the first and/or second air curtain based on the received data.

21. The method of claim 19, further comprising operating the first and second fan so as to move the location of the convective mixing zone from one side of the open fronted cabinet to another.

22. The method of claim 19, further comprising sounding an alarm when the open fronted cabinet is outside of predetermined working parameters.

23. The method of claim 19, wherein the first and second passageway comprise an adjustable aperture, the method further comprising adjusting a volume and/or size of the adjustable aperture of the first and/or second aperture.

24. An open fronted cabinet, having a first food display zone for the temporary display of a heated food item,
the first food display zone comprising:
a first fan associated with a first temperature control element and a first passageway, wherein the first fan is configured to direct a first airflow, through the first passageway, into the first food display zone so as to create a first air curtain in the first food display zone;
the open fronted cabinet further comprising a controller, the controller configured to:
receive an input from a first source, said input indicative of an event which would affect the formation of the first air curtain; and
adjust the speed of the first fan and/or the temperature of the first temperature control element thereby controlling the formation of the first air curtain based on the received input.

25. (canceled)

26. The open fronted cabinet of claim 24, wherein the first source is a sensor configured to measure an environment in which the open fronted cabinet is placed.

27. (canceled)

28. The open fronted cabinet of claim 26, wherein the sensor is configured to measure a change in the air flow around the cabinet and/or first food display zone.

29. (canceled)

30. (canceled)

31. The open fronted cabinet of claim 24, further comprising one or more further food display zones;
wherein each further food display zone has a fan and temperature control element, and the controller is configured to adjust the speed of the fan and/or the temperature of the temperature control element in each food display zone individually, thereby controlling the formation of the first air curtain in each food display zone separately.

32. (canceled)

33. (canceled)
